(19) United States
(12) Patent Application Publication
(10) Pub. No.: US 2007/0177565 A1
(43) Pub. Date: Aug. 2, 2007

(54) Method of controlling data rate for a forward data service in a cdma 2000-1x system

(75) Inventor: Jung Han Lee, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited

(21) Appl. No.: 10/569,041

(22) PCT Filed: Sep. 24, 2004
(86) PCT No.: PCT/KR04/02471

§ 371 Date: Feb. 14, 2007

(30) Foreign Application Priority Data
Sep. 30, 2003 (KR) 10-2003-0067738

(51) Int. Cl. H04B 7/216; H04Q 7/00

(52) U.S. Cl. 370/342; 370/332

(57) ABSTRACT

The present invention relates to a method for controlling a data rate for a forward data service in a CDMA 2000-1x system. Conventionally, the data rate from a base station to a mobile station is constant regardless of the wireless environment of the mobile station. As such, resources used in the base station for communication with the mobile station may be wasted if the data throughput is low due to the poor wireless environment. The present invention, however, resolves this problem by varying the data rate according to Energy of Carriers/Interference of Others' (Ec/Io) of the data, which indicates the wireless environment of the mobile station. With the present invention, the resources in a base station, which would be wasted for communication with a mobile station in a poor wireless environment, can be used for other mobile stations. Thus, the resources of the overall CDMA 2000-1x system can be used efficiently.

### TECHNICAL FIELD

The present invention generally relates to a method for controlling a data rate for a forward data service in a CDMA 2000-1x system, and more particularly to a method wherein the data rate is varied according to Energy of Carriers/Interference of Others' (Ec/Io) of data, which indicates the wireless environment of a mobile station, by using a Power Measurement Report Message (PMRM).

### BACKGROUND ART

Generally, the data rate scheduling of a forward data service in a CDMA 2000-1x system varies according to manufacturing. Therefore, it is not fixed.

If the wireless environment in a data service using supplemental channels is poor, then the data throughput can be low. In the prior art, if the data throughput is low due to the poor wireless environment, then resources used in the base station for communication with a mobile station are not varied. Accordingly, such resources can be wasted and interference with other channels can occur.

### DISCLOSURE OF INVENTION

### Technical Problem

Thus, the present invention is provided in order to solve the above-described problems associated with the prior art. The objective of the present invention is to provide a method for controlling a data rate for a forward data service using supplemented channels in a CDMA 2000-1x system.

### Technical Solution

In accordance with the present invention, a method for controlling a data rate for a forward data service in a CDMA 2000-1x system is provided. The method comprises the following steps: at a base station, transmitting data; at a mobile station, upon receipt of the data, checking Energy of Carriers/Interference of Others' (Ec/Io) of the received data; at the mobile station, determining the data rate for the Ec/Io; at the mobile station, comparing the determined data rate with an original data rate; at the mobile station, if the above two data rates are equal, continuously checking Ec/Io of the received data and transmitting to the base station a Power Measurement Report

Message (PM) including information on the determined data rate; at the base station, upon receipt of the PMRM, retrieving the information on the determined data rate from the PMRM; and at the base station, transmitting data to the mobile station according to the determined data rate.

### BRIEF DESCRIPTION OF THE DRAWINGS

Understanding that these drawings depict only typical embodiments of the invention and are, therefore, not to be considered limiting of its scope, the invention will be described with additional specificity and detail through use of the accompanying drawings in which:

FIG. 1 illustrates an exemplary table showing data rates for respective Ec/Ios in accordance with the present invention.

FIG. 2 illustrates a process of controlling a data rate by using a PMRM when the data rate is varied in a forward data service in accordance with the present invention.

### BEST MODE FOR CARRYING OUT THE INVENTION

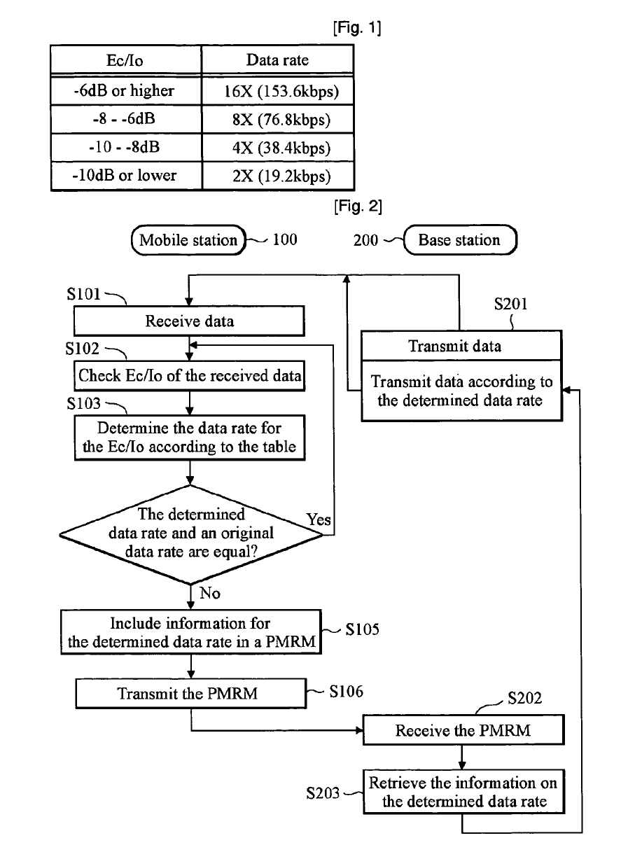

It will be readily understood that the components and steps of the present invention, as generally described and illustrated in the Figures herein and accompanying text, could be arranged and designed in a wide variety of different configurations while still utilizing the inventive concept. Thus, the following detailed description of the preferred embodiments of the method of the present invention, as represented in FIGS. 1 through 2 and accompanying text, is not intended to limit the scope of the invention, as claimed. It is merely representative of the presently preferred embodiments of the invention. The presently preferred embodiments of the invention will be best understood by reference to the drawings.

FIG. 1 illustrates an exemplary table showing data rates for respective Ec/Ios in accordance with the present invention. FIG. 2 illustrates a process of controlling a data rate by using a PMRM when the data rate is varied in a forward data service in accordance with the present invention.

As shown in FIGS. 1 and 2, a method for controlling a data rate for a forward data service in a CDMA 2000-1x system in accordance with the present invention comprises the following steps: at a base station, transmitting data (S201); at a mobile station, receiving the data (S101); at a mobile station, upon receipt of the data, checking Energy of Carriers/Interference of Others' (Ec/Io) of the received data (S102); at the mobile station, determining the data rate for the Ec/Io according to a table (S103); at the mobile station, comparing the determined data rate with an original data rate (S104); at the mobile station, if the above two data rates are equal, continuously checking Ec/Io of the received data (S105); at the mobile station, if the above two data rates are not equal, including information on the determined data rate in a Power Measurement Report Message (PMRM) (S105); at the mobile station, transmitting to the base station the PMRM (S106); at the base station, receiving the PMRM (S202); at the base station, upon receipt of the PMRM, retrieving the information on the determined data rate from the PMRM (S201); and at the base station, transmitting data to the mobile station according to the determined data rate (S203).

As shown in FIG. 2, in a process of applying a new data rate by transmitting a PMRM to a base station when data rate is varied in a forward data service in accordance with the present invention, a base station 200 transmits data to a mobile station 100 (S201). The mobile station 100 then receives the data (S101) and checks Ec/Io of the received data (S102).

Next, after checking Ec/Io (S102), the mobile station 100 determines the data rate according to Ec/Io as defined in the table shown in FIG. 1 (S103).

Thereafter, the mobile station 100 compares the determined data rate with an original data rate (S104). If the above two data rates are equal, then the mobile station 100 continuously checks Ec/Io of received data (S102). If the above two data rates are not equal, then the mobile station 100 transmits the determined data rate to the base station 200 (S105, S106).

At this time, a message necessary for transmitting the determined data rate to the base station 200 is generated by incorporating the information on the determined data rate into a PMRM used in power control of Radio configuration (RC1) (S105, S106).

On the other hand, the base station 200 receives the PMRM (S202), retrieves the information on the determined data rate from the PMRM (S203), and transmits data to the mobile station 100 according to the determined data rate (S201).

As stated above, varying the data rate according to the wireless environment of the mobile station allows the forward link power to be used efficiently.

Further, since a PMRM is not transmitted when the data rate is constant, resource consumption for reverse links and interference can be minimized. Such configuration can improve performance and capacity of the forward and reverse links.

A method for controlling a data rate for a forward data service using supplemental channels in a CDMA 2000-1x system in accordance with the present invention, comprises the steps of: at the mobile station, determining data rate for Ec/Io; at the mobile station, transmitting to a base station a Power Measurement Report Message (PMRM), which was used in forward power control in 2G, including information on the determined data rate; at the base station, upon receipt of the PMRM, retrieving the information on the determined data rate from the PMRM; and at the base station, transmitting data to the mobile station according to the determined data rate.

While the present invention has been described above in conjunction with specific preferred embodiments for a method of controlling a data rate for a forward data service in a CDMA 2000-1x system, it is evident that numerous alternatives, modifications and variations will be apparent to those skilled in the art without departing from the scope of the present invention. Thus, the breadth and scope of the present invention should not be limited by any of the above-described exemplary embodiments, but should be defined only in accordance with the following claims and their equivalents.

### INDUSTRIAL APPLICABILITY

According to the present invention, since the resources can be used efficiently and interference can be reduced by varying the data rate according to the wireless environment of a forward data service in a CDMA 2000-1x system, it can provide an optimal service to several subscribers concurrently. Moreover, the present invention can be applied in the field of data rate scheduling.

With the present invention, the resources in a base station, which would otherwise be wasted for communication with a mobile station in a poor wireless environment, can be used for other mobile stations. Thus, the resources of the overall CDMA 2000-1x system can be used efficiently and interference can be minimized. Further, the forward link power can be used efficiently by varying the data rate according to the wireless environment.

Also, since a PMRM is not transmitted when the data rate is constant, resource consumption for reverse links and interference can be minimized. Such configuration can improve performance and capacity of forward and reverse links.

1. A method for controlling a data rate for a forward data service in a CDMA 2000-1x system, the method comprising the steps of:
at a base station, transmitting data;
at a mobile station, upon receipt of the data, checking Energy of Carriers/Interference of Others' (Ec/Io) of the received data;
at the mobile station, determining the data rate for the Ec/Io;
at the mobile station, comparing the determined data rate with an origins data rate;
at the mobile station, if the above two data rates are equal, continuously checking Ec/Io of the received data and transmitting to the base station a Power Measurement Report Message (PMRM) including information on the determined data rate;
at the base station, upon receipt of the PMRM, retrieving the information on the determined data rate from the PMRM; and
at the base station, transmitting data to the mobile station according to the determined data rate.
